(19) United States
(12) Patent Application Publication
(10) Pub. No.: US 2006/0064299 A1
(43) Pub. Date: Mar. 23, 2006

(54) Device and method for analyzing an information signal

(75) Inventors: Christian Uhle, Ilmenau (DE); Christian Dittmar, Ilmenau (DE); Thomas Sporer, Fuerth (DE)

Correspondence Address: BEYER WEAVER & THOMAS LLP, P.O. BOX 70250, OAKLAND, CA, 94612-0250, US

(73) Assignee: Fraunhofer-Gesellschaft zur Foerderung der angewandten Forschung e.V.

(21) Appl. No.: 11/225,557

(22) Filed: Sep. 13, 2005

Related U.S. Application Data
(63) Continuation of application No. PCT/EP04/02846, filed on Mar. 18, 2004.

(30) Foreign Application Priority Data
Mar. 21, 2003 (DE) 103 13 875.7

(51) Int. Cl. G10L 15/06; G10L 21/00

(52) U.S. Cl. 704/212; 704/243

(57) ABSTRACT

For analyzing an information signal consisting of a superposition of partial signals, wherein a partial signal originates from an individual source, the information signal is first decomposed into several component signals. Then one or more features are calculated for each component signal, wherein the feature(s) is/are defined so that it/they provide(s) a statement on an information content of the component signal. Finally, an association of the component signals with at least two subspaces is performed on the basis of the features calculated for the component signals. By feature extraction on the component signal level, an efficient subspace decomposition which is meaningful with respect to a present audio scene is achieved.

### CROSS-REFERENCE TO RELATED APPLICATION

This application is a continuation of copending International Application No. PCT/EP2004/002846, filed on Mar. 18, 2004, which designated the United States and was not published in English.

### BACKGROUND OF THE INVENTION

1. Field of the Invention

The present invention relates to the analysis of information signals, such as audio signals, and particularly to the analysis of information signals consisting of a superposition of partial signals, wherein a partial signal originates from an individual source.

2. Description of the Related Art

The progressing development of digital distribution media for multimedia contents has resulted in a large variety of offered data. For the human user, the limit of manageability has long since been passed. Thus the importance of the content description of the data by metadata is increasing. Basically the goal is to make not only text files, but also, for example, music files, video files or other information signal files searchable, wherein the same comfort is desired as in current text databases. An approach in this respect is the known MPEG 7 standard.

Particularly in the analysis of audio signals, i.e. signals including music and/or language, the extraction of fingerprints is very important.

It is further desired to “enrich” audio data with metadata to retrieve metadata, for example for a piece of music, on the basis of a fingerprint. On the one hand, the “fingerprint” should be meaningful, and on the other hand it should be as short and concise as possible. “Fingerprint” thus refers to a compressed information signal generated from a music signal which does not contain the metadata, but serves for referencing to the metadata, for example by a search in a database, for example in a system for the identification of audio material (“AudioID”).

Normally, music data consist of the superposition of partial signals from individual sources. While, in pop music, there are typically relatively few individual sources, i.e. the singer, the guitar, the bass guitar, the drums and a keyboard, the number of sources may become very large for a piece of orchestra music. A piece of orchestra music and a piece of pop music consist, for example, of a superposition of the tones emitted by the individual instruments. A piece of orchestra music and/or any piece of music thus represents a superposition of partial signals from individual sources, wherein the partial signals are the tones generated by the individual instruments of the orchestra and/or the pop music ensemble, and wherein the individual instruments are individual sources.

Alternatively, groups of original sources may also be regarded as individual sources, so that at least two individual sources may be assigned to a signal.

In the following, an analysis of a general information signal is represented, by way of example only, with respect to an orchestra signal. The analysis of an orchestra signal may be performed in many ways. For example, it may be desired to recognize the individual instruments and to extract the individual signals of the instruments from the overall signal and, if applicable, to translate them into musical notation, wherein the musical notation would act as “metadata”. Other ways of analyzing are to extract a dominant rhythm, wherein a rhythm extraction is done better on the basis of the percussion instruments than on the basis of the more tone-giving instruments, which are also referred to as harmonic sustained instruments. While percussion instruments typically include kettledrums, drums, rattles and other percussion instruments, all other instruments, such as violins, wind instruments, etc., belong to the harmonic sustained instruments.

Furthermore, all the acoustic or synthetic sound generators which, due to their sound properties, contribute to the rhythm section (for example rhythm guitar) are considered to be percussion instruments.

Thus, for example, it would be desirable for the rhythm extraction of a piece of music to extract only percussive components from the overall piece of music and to then perform a rhythm detection on the basis of these percussive components, without the rhythm detection being “disturbed” by signals from the harmonic sustained instruments.

On the other hand, any analysis aiming to extract metadata which exclusively requires information of the harmonic sustained instruments (for example a harmonic or melodic analysis) will profit from a preceding separation and further processing of the harmonic sustained components.

Recently there was a report in this context on the use of the technology of Blind Source Separation (BSS) and Independent Component Analysis (ICA) for signal processing and signal analysis. Areas of application are particularly to be found in biomedical technology, communication technology, artificial intelligence and image processing.

Generally, the term BSS includes technologies for the separation of signals from a mix of signals with a minimum of previous knowledge of the nature of the signals and the mixing process. The ICA is a method making use of the assumption that the sources on which a mix is based are, at least to a certain extent, statistically independent of each other. Furthermore, the mixing process is assumed to be invariable in time, and the number of the observed mix signals is assumed not to be smaller than the number of the source signals on which the mix is based.

The Independent Subspace Analysis (ISA) represents an extension of the ICA, relaxing the restriction of the statistical independence of the sources. Here, the components are divided into independent subspaces whose components do not have to be statistically independent. By a transformation of the music signal, a multidimensional representation of the mix signal is determined, corresponding to the last assumption for the ICA. Various methods for calculating the independent components were developed in the last few years. Relevant literature, some of it also dealing with the analysis of audio signals, includes:
1. J. Karhunen, “Neural approaches to independent component analysis and source separation”, Proceedings of the European Symposium on Artificial Neural Networks, pp. 249-266, Bruges, 1996.
2. M. A. Casey and A. Westner, “Separation of Mixed Audio Sources by Independent Subspace Analysis”, Proceedings of the International Computer Music Conference, Berlin, 2000.
3. J.-F. Cardoso, “Multidimensional independent component analysis”, Proceedings of ICASSP'98, Seattle, 1998.
4. A. Hyvärinen, P. O. Hoyer and M. Inki, “Topographic Independent analysis”, Neural Computation, 13(7), pp. 1525-1558, 2001.

5. S. Dubnov, “Extracting Sound Objects by Independent Subspace Analysis”, Proceedings of AES 22^{nd} International Conference on Virtual, Synthetic and Entertainment Audio, Helsinki, 2002.
6. J.-F. Cardoso and A. Souloumiac, “Blind beamforming for non Gaussian signals” IEE Proceedings, vol. 140, no. 6, pp. 362-370, 1993.

The second listed publication by Casey will be discussed below as an example for the prior art. This publication describes a method for separating mixed audio sources by the technique of independent subspace analysis. For this, an audio signal is split into individual component signals using BSS techniques. In order to determine which of the individual component signals belong to a multicomponent subspace, grouping is performed such that the similarity of the components among each other is represented by a so-called ixegram. The ixegram is referred to as a cross-entropy matrix of the independent components among each other. It is calculated by examining all individual component signals in pairs in a correlation calculation to find a measure for how similar two components are. An exhaustive similarity calculation in pairs is therefore performed across all component signals, so that the result is a similarity matrix in which all component signals are plotted along a y-axis, and in which further all component signals are also plotted along the x-axis. This two-dimensional array provides a similarity measure for each component signal with a respective other component signal. The ixegram, i.e. the two-dimensional matrix, is now used to perform clustering, wherein for this a grouping is performed using a cluster algorithm on the basis of diadic data. In order to perform an optimal partitioning of the ixegram into k classes, a cost function is defined measuring the compactness within a cluster and determining the homogeneity between clusters. The cost function is minimized, so that the result is finally an association of individual components with individual subspaces. Applied to a signal representing a speaker in the context of a continuous waterfall noise, the result is the speaker as subspace, wherein the reconstructed information signal of the speaker subspace shows a significant attenuation of the waterfall noise.

What is disadvantageous in the described concepts is the fact that the case is very likely to occur that the signal components of a source will end up on different component signals. This is why, as described above, a complex and calculating time-intensive similarity calculation is performed among all component signals to obtain the two-dimensional similarity matrix, on the basis of which there is then finally performed a division of component signals into subspaces by means of a cost function to be minimized.

It is further disadvantageous that, in the case in which there are several individual sources, i.e. where the output signal is not known a priori, although there will be a similarity distribution after lengthy calculation, the similarity distribution itself does not provide any actual insight into the actual audio scene. Thus the observer only knows that certain component signals are similar to each other with respect to the minimized cost function. He/she does not know, however, what information is carried by these finally obtained subspaces and/or which original individual source or which group of individual sources is represented by a subspace.

### SUMMARY OF THE INVENTION

It is the object of the present invention to provide a more efficient and more intuitive concept for analyzing information signals.

In accordance with a first aspect, the present invention provides a device for analyzing an information signal, wherein the information signal is an audio signal consisting of a superposition of partial signals, wherein the partial signals originate from individual sources together forming the audio signal, wherein the device includes a unit for decomposing the information signal into several component signals; a unit for calculating a feature for each individual component signal, wherein the feature is defined so that it is correlated with one source characteristic for one subspace and with another source characteristic for another subspace, wherein one or more individual sources are associated with each subspace, and wherein the one or more individual sources associated with the one subspace differ from the one or more individual sources associated with the other subspace; and a unit for associating the component signals with at least two subspaces on the basis of the features for the component signals, so that the one subspace includes component signals corresponding to the one or more individual sources associated with the one subspace, and that the other subspace includes component signals corresponding to the one or more individual sources associated with the other subspace.

In accordance with a second aspect, the present invention provides a method for analyzing an information signal, wherein the information signal is an audio signal consisting of a superposition of partial signals, wherein the partial signals originate from individual sources together forming the audio signal, the method having the steps of decomposing the information signal into several component signals; calculating a feature for each individual component signal, wherein the feature is defined so that it is correlated with one source characteristic for one subspace and with another source characteristic for another subspace, wherein one or more individual sources are associated with each subspace, and wherein the one or more individual sources associated with the one subspace differ from the one or more individual sources associated with the other subspace; and associating the component signals with at least two subspaces on the basis of the features for the component signals, so that the one subspace includes component signals corresponding to the one or more individual sources associated with the one subspace, and that the other subspace includes component signals corresponding to the one or more individual sources associated with the other subspace.

In accordance with a third aspect, the present invention provides a computer program with a program code for performing a method according to the above mentioned method, when the program runs on a computer.

The present invention is based on the finding that it is necessary to depart from the complex pair similarity analysis of the component signals to arrive at a more efficient concept. Instead, an association of the component signals with individual subspaces is performed on the basis of a feature calculated for each component signal. Thus component signals get into one subspace whose features meet a certain criterion, for example to be smaller than a threshold. Other component signals whose features meet another criterion or do not meet the mentioned criterion then get into the other subspace.

Alternatively, the association of the component signals with the subspaces may take place by means of a conventional classification apparatus carrying out an association not only on the basis of one feature, but based on the entirety of the available features. All known classification apparatus capable of processing multidimensional feature vectors (nearest neighbor, k nearest neighbor, fuzzy classificator, neuronal networks, Bayes classificator, hierarchical classificators, . . . ) may be used as classification apparatus.

This already achieves a simple, but efficiently performable classification of the component signals into subspaces. Two further important advantages result from the possibility of presetting the feature. The one advantage is to preset a feature adapted to an audio scene and/or desired properties. If a feature is preset which is, for example, uniquely correlated with percussiveness, i.e. with a sound property of percussion instruments, a division of the component signals into non-percussive and percussive component signals may be easily achieved completely without knowledge of the piece itself. The extraction of percussive component signals is particularly important for a subsequent rhythm extraction.

If an extraction of partial signals of a specific individual source or of a group of individual sources is desired, this may be easily done by presetting another feature correlated with the partial signal of the wanted individual source or correlated with partial signals of a group of individual sources, depending on what is desired.

The other advantage of the possibility of presetting the feature is that the effort is easily scalable. For example, it is quite sufficient for a merely rough percussiveness extraction to preset a feature that is reasonably correlated with the percussive property of a source. Typically, it will be relatively easy to implement this feature in the calculating effort, so that a fast information signal analysis can be managed. If, however, speed is not crucial, features or feature combinations of any complexity may be preset which instead have a higher correlation with an individual source and/or a wanted group of individual sources.

The fact of presetting the feature, i.e. examining the component signals based on a “normal” given from outside instead of an evaluation of the component signals among each other and the subsequent minimization of a cost function further provides higher intuition in that, directly after the association of the component signals with the individual subspaces, information on the audio scene is clear in that a user already has an insight into the audio scene based on the component signals in the subspaces, because he had preset the feature based on which the division into the subspaces took place depending on the properties of the audio scene that were of interest to him.

### BRIEF DESCRIPTION OF THE DRAWINGS

Preferred embodiments of the present invention will be explained in detail in the following with respect to the accompanying drawings, in which:

FIG. 1 is a block circuit diagram of the inventive concept for analyzing an information signal;

FIG. 2 is a block circuit diagram of a method according to a preferred embodiment of the present invention;

FIG. 3a is a comparison of an actual amplitude envelope and a model envelope for a harmonic sustained component signal;

FIG. 3b is a comparison of an actual amplitude envelope and a model amplitude envelope for a percussive component signal;

FIG. 4a is a comparison of an actual frequency spectrum and a model spectrum for a harmonic sustained component signal; and

FIG. 4b is a comparison of a frequency spectrum of an actual and a modeled signal for a percussive component signal.

### DESCRIPTION OF THE PREFERRED EMBODIMENTS

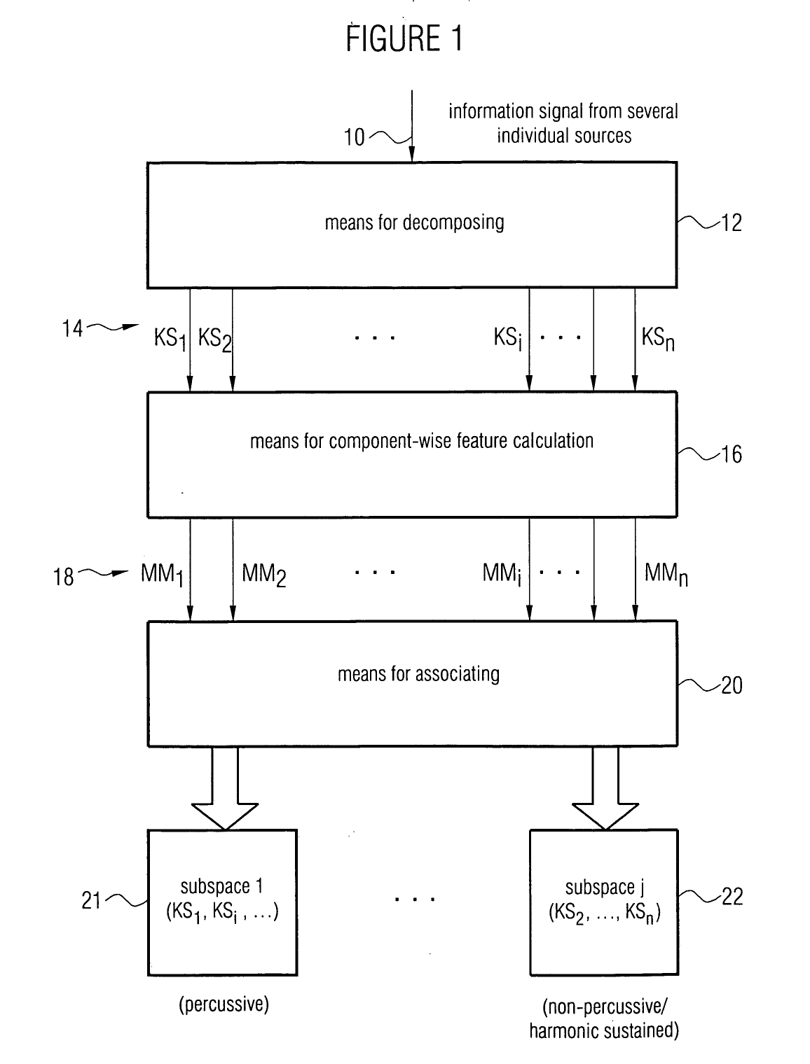

FIG. 1 shows a fundamental block circuit diagram of an inventive device for analyzing an information signal consisting of a superposition of partial signals, wherein a partial signal originates from an individual source. The information signal consisting of the several partial signals is supplied to means 12 for decomposing the information signal into several component signals 14 via input 10. On the output side, the means 12 for decomposing provides the component signals KS1, KS2, . . . , KSi, . . . KSn, as shown in FIG. 1. The component signals 14 are further supplied to means 16 for component-wise feature calculating. Specifically, the means 16 is designed to calculate one feature or several features for each component signal. Particularly, the feature(s) are defined so that a statement on an information content of the component signal is achievable. Thus, according to the invention, the at least one feature is chosen such that it is correlated with a wanted property of the component signal. In other words, this means that a feature is used that provides, for example, a high value for a component signal having a wanted property, and provides a smaller value for a component signal that does not have the wanted property or has it to a lesser extent than the first observed signal (or vice versa).

Thus, a correlation between a wanted information content of a component signal and a feature to be preset is obtained by a rule for calculating the feature carried out by the means 16.

Generally, the means 16 for component-wise feature calculation will carry out a calculating rule which is the same for all component signals and provides the desired correlation. The result is, for each component signal, a feature assigned to the same, wherein the features are designated 18 in their entirety in FIG. 1.

The features 18 are supplied to means 20 for associating the component signals with at least two subspaces 21 and 22, wherein a subspace comprises information on an information signal of an individual source or information on a superposition of information signals in a group of individual sources.

Specifically, the means 20 for associating examines, for example, the feature MM1 assigned to the component signal KS1 to then determine, for example, that the component signal KS1 belongs to the first subspace 21. The means 20 will perform this procedure for the other component signals KS2, . . . KSi, . . . , KSn to then achieve an exemplary association of diverse component signals with the first subspace 21 and of other component signals with the second subspace 22, as shown in FIG. 1. The component signals associated in a subspace thus include information on a partial signal of an individual source or, depending on the chosen feature, also include information on a superposition of partial signals of a group of individual sources. If, for example, the feature on which the means 16 is based was chosen so that it has a correlation with the percussiveness of a component signal, there will be percussive component signals in the first subspace 21 after associating, while there will be non-percussive component signals, i.e. component signals based on harmonic sustained sources and/or instruments, in the second subspace 22 after the association by the means 20.

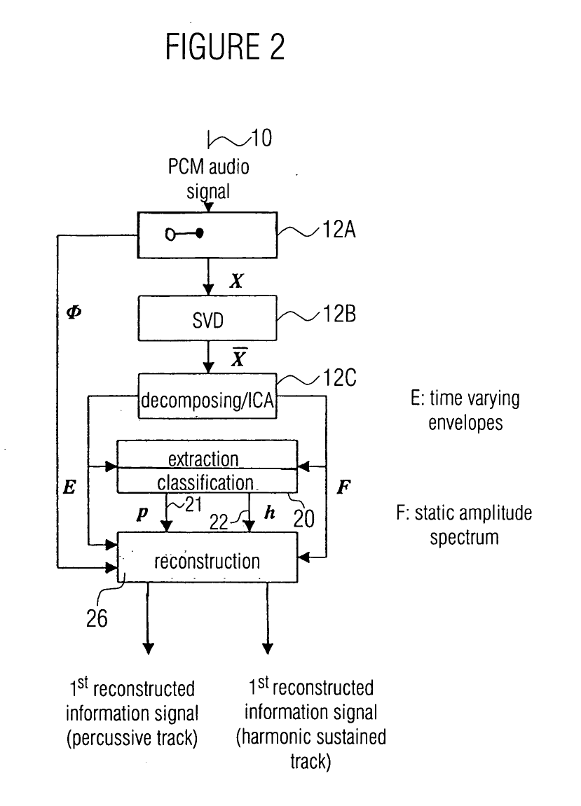

Before discussing a preferred embodiment of the present invention with respect to FIG. 2, the invention will be summarized once more in that first individual components are calculated and that then the calculated components are grouped into subspaces on the basis of one or more features. After a completed ISA, we have thus the estimated independent components. The components are preferably described by a static amplitude spectrum and a time variable amplitude envelope. By multiplication of amplitude spectrum and amplitude envelope, an amplitude spectrogram is reconstructed. The phase information required for the preferably performed reconstruction of the time signals is adopted, in one embodiment, as it was determined in the transformation into the frequency domain. Particularly, as discussed above, the components are grouped into subspaces based on certain criteria, wherein either one or more criteria may be used for this. A criterion is particularly a feature that has been determined for a component signal.

In the following, a preferred embodiment of the present invention will be discussed with respect to FIG. 2. FIG. 2 shows a flow diagram and/or a schematic block circuit diagram of a device for analyzing an information signal, wherein the information signal is supplied via the input 10 and is, for example, a PCM audio signal (PCM=pulse code modulation).

In the embodiment shown in FIG. 2, the means 12 for decomposing illustrated in FIG. 1 includes a time domain-frequency domain conversion means 12a. The time domain-frequency domain conversion means is preferably implemented to perform a short-time Fourier transform (STFT), wherein there is preferably used a Hamming window. By windowing, a block of time-discrete samples is generated from a sequence of time-discrete samples, the block then being converted to the frequency domain. In this context, short-time Fourier transform means that a Fourier transform is used having a length of 512 to 4096 time samples, wherein a length of up to 4096 samples is preferred regarding a good compromise between time and frequency resolution. This results in 2048 spectral components. A stream of time-discrete audio samples at the input 10 is thus transformed into a sequence of short-time spectra, wherein a short-time spectrum provides n frequency values, and wherein the sequence of samples is converted to a sequence of m short-time spectra and/or frames. If the signal is a real input signal, 512 complex spectral values and/or 512 magnitudes for spectral components and 512 associated phases for spectral components will result by the 1024 points Fourier transform. The means 12a is particularly designed to pass the magnitude spectrum X to a subsequent means 12b to be described in the following, while the phase information φ is split off to be supplied only to a final reconstruction means 26, as shown in FIG. 2. Besides the supply of all 512 spectral components to the means 12b, the supply of a subset of all spectral components is possible, wherein there are preferably supplied the spectral components corresponding to the lower frequencies and the spectral components corresponding to the high frequencies are omitted.

It is to be noted at this point that the supply of the magnitude spectrum X to the SVD means 12b is only exemplary and is performed to reduce the calculating effort. The decomposition of the audio signal into component signals could also be performed with a sequence of complex spectra, wherein the splitting off of the phase information does not have to be performed then.

The means 12b is designed to perform a singular value decomposition (SVD), as known in the art. For this, consider the transposed spectrogram as matrix X^{T}. It is to be noted at this point that the matrix X has the dimension n×m, such that, in one column of the matrix, one short-time spectrum of the audio data is located at the input, and that, in the next column of the matrix, a next short-time spectrum of the audio signal is located at the input 10, etc. The matrix X thus contains n×m values, wherein a row of the matrix represents a certain frequency value between a lower frequency limit (preferably multiplied by a frequency delta depending on the sample frequency and the window size) and an upper frequency limit maximally corresponding to the Nyquist frequency, while a column represents a certain point in time and/or a certain block from the sequence of time-discrete samples at the input 10.

Preferably the transposed amplitude spectrogram X^{T} is supplied to the means 12b. Alternatively, however, it is possible to supply the amplitude spectrogram X to the means 12b. When supplying the transposed amplitude spectrogram X^{T}, the ICA described below results in the determination of component signals whose amplitude envelopes are maximally independent. A further, following ICA of the frequency weightings determined in the first ICA results in the determination of component signals whose frequency weightings are maximally independent.

The singular value decomposition of the matrix X^{T} is represented by the following equation:
X^{T}=U·D·V^{T} (2)

The calculation of the SVD is equivalent to an eigenvalue decomposition of the covariance matrix of X^{T}, as it is known in the art. Common SVD algorithms provide a diagonal matrix D of singular values in decreasing order and two orthogonal matrices U and V^{T}. The matrix U=(u₁, . . . uₘ), also referred to as the row base, holds the left singular vectors, which are equal to the eigenvectors of X·X^{T}. The matrix V=(v₁, . . . , vₙ), also referred to as column base, holds the right singular vectors, which are equal to the eigenvectors of X^{T}·X. The singular vectors are linearly independent and thus provide the orthonormal base for a rotation transformation in the direction of the principal component.

Before the functionality of the SVD means 12b is discussed further, there will be a more detailed discussion of the ICA technology and/or BSS technology. The estimation of underlying partial signals from observations of their linear mixes using a minimum of a priori information is referred to as BSS (Blind Source Separation). This technology is described in detail in literature no. 1 by J. Karhunen listed in the beginning. The BSS technology prevails in various areas, including biomedicine, communications and the analysis of audio scenes. One of the different approaches for the BSS is the ICA technology, wherein ICA stands for Independent Component Analysis. The ICA technology was introduced in the early 1980ies and presents itself as follows. The ICA assumes that the individual source signals, i.e. the partial signals of the individual sources, are mutually statistically independent. This property is used in the algorithmic identification of the individual sources. The ICA model expresses the observation signal x as the product of a mixing matrix A and a vector of statistically independent signals s, i.e. according to the following equation:
x=A·s (1)

A is a k×1 (pseudo) invertible matrix with orthogonal columns. s is a random vector with 1 source signals. x is a k-dimensional vector of observations with k equal to or greater than l. Further assumptions are that each source signal s is characterized by a stationary stochastic process with an average value of 0, and that only one of them has a Gaussian distribution. In literature, a noise term is often added in the model, namely on the input side. For reasons of simplicity, however, it is omitted in the following. The condition that there have to be at least as many observable mix signals as source signals restricts the application of the ICA to real problems, such as in the present analysis of an information signal consisting of a superposition of partial signals, wherein a partial signal originates from an individual source. Particularly, there are often fewer sensors than sources. A further restriction is the assumption that the components are mutually statistically independent.

In order to overcome these restrictions, there are various extensions for the original ICA technology, discussed in the publications no. 3 by Cardoso and no. 4 by Hyvärinen, which are listed above. As mentioned before, such technologies are based on the similarity determination of different component signals and on the grouping of the same according to a cost function to be minimized.

According to the invention, however, the components are divided into different subspaces whose components are not independent. In order to satisfy the assumption k≧1, the signal is transformed, by the means 12a, to a time-frequency representation, i.e. a spectrogram, which, according to the invention, is regarded as a multichannel representation of the signal.

Subsequently, the functionality of the SVD means 12b will be discussed further. In particular, there is now an intervention in the diagonal matrix D which, as described above, includes the singular values in decreasing order with respect to size. In principle, each singular value would result in an own component signal. An observation of the diagonal matrix D has shown, however, that many singular values have relatively small values towards higher columns of the matrix D. It is particularly to be noted that the singular values represent the standard deviations of the principal components from X. These standard deviations are proportional to the amount of information contained in a corresponding principal component. Small singular values therefore indicate a signal having a low standard deviation and thus carrying relatively little information. A direct value would have a standard deviation of 0 and would only carry information on the direct component itself, but no dynamic information from a signal. Therefore, according to the invention, only singular values having a magnitude larger than an adjustable threshold are further used for the calculation of the component signals. It has been found that the threshold may be adjusted such that between about 10 and 30 singular values are selected for further processing. Alternatively, a fixed number of singular values may also be selected for further processing.

A linear transform matrix T is calculated by the means 12b according to the following equation, wherein \overline{D} is a submatrix consisting of the upper d rows of D:
T=\overline{D}·V^{T} (3)

Die transform matrix T is multiplied by the spectrogram X, resulting in a representation \overline{X} with reduced rank and maximally informative orientation. This representation \overline{X} is defined as follows:
\overline{X}=T·X (4)

The SVD means thus provides a maximally informative spectrogram \overline{X}, as defined above. The number d of the obtained dimensions, i.e. singular values, is a meaningful parameter for the whole process. As has already been mentioned, observations have shown that it is sufficient to further process between 10 and 30 dimensions. Fewer dimensions result in a non-complete decomposition, while too many dimensions do not result in a reasonable improvement, but only increase the calculating effort and make the clustering method more complicated.

As has been discussed, there are as many component signals in the end as singular values were selected. If too many singular values are selected, too many component signals will be yielded, such that a partial signal from an individual source finally results in several component signals. If, however, too few singular values are taken, a component signal represents a superposition of several partial signals from several individual sources. Therefore the invention aims to limit the number of the singular values in the SVD means 12b as described above, namely so that slightly more singular values are taken than distinguishable individual sources are expected to have a reserve so that, in any case, there will be no non-complete decomposition. A slightly excessive number of singular values, for example in the range of 10% of the expected individual sources, is not very problematic, because, according to the invention, an association is performed anyway, i.e. various component signals are superimposed again by associating them with the one or the other subspace.

Subsequently, the functionality of the ICA means 12c in FIG. 2 will be discussed which, in a way, represents the last stage of the means 12 for decomposing of FIG. 1. As discussed above, the source separating model is a transformation, wherein the observations x are obtained by a multiplication of the source signals s by an unknown mixing matrix A. The spectrogram \overline{X} of reduced rank obtained by the SVD means 12b may be interpreted as observation matrix, wherein each column is regarded as realizations of a single observation. According to the invention, it is preferred to use the jade ICA algorithm for the calculation of A. This algorithm is discussed in detail in the specialist publication no. 6 by J.-F. Cardoso and A. Souloumiac, listed above under no. 6. This algorithm is preferred particularly because it minimizes higher order correlations by a linked approximated diagonalization of eigenmatrices of cross cumulant tensors. The estimated mixing matrix A is calculated to calculate the independent components and/or component signals. Their pseudo inverse A⁻¹ represents the “unmixing matrix”, by which the independent sources, i.e. component signals, may be extracted. Thus, when the mixing matrix A has been calculated, the mixing matrix A has to be inverted to obtain A⁻¹. Then the following equation may be calculated:
E=A⁻¹·\overline{X} (5)

Thus independent time amplitude envelopes E are yielded.

Subsequently, the independent frequency weightings F are calculated by calculating the subsequent equation and subsequently performing a pseudo inversion.
F⁻¹=A⁻¹·T (6)

The above equation yields the inverse matrix F⁻¹ which, as discussed, still has to be inverted to obtain the frequency weightings F for the component signals. The independent spectrograms and/or component signals are then obtained by multiplying a column of F by the corresponding row of E, which is represented in an equation as follows:
S_{c}=F_{u,c}·E_{c,v} (7)

The index u runs from 1 to n. The index v runs from 1 to m. The index c runs from 1 to d. The time signals of the individual component signals represented by equation 7 are obtained by an inverse short-time Fourier transform of the spectrogram S_{c}. For reasons of clarity, the component signals were presented in matrix notation in the above equations.

An individual component signal is calculated in the frequency domain processing by the means 12c preferred above such that a component signal is represented by a static amplitude spectrum, i.e. a column of the matrix F, and that the component signal is further represented by a time variable amplitude envelope, i.e. a row of E associated to the column of F. A component signal in the time domain would thus result from the spectrum F of a component signal being multiplied by an associated value of the amplitude envelope E. Then the same spectrum F is multiplied by the next value from the amplitude envelope E, etc. The result is thus a sequence of spectra multiplied by different values which then, after an inverse short-time Fourier transform, represent a sequence of time samples forming a time component signal.

Depending on the total number of extracted components, the decomposition may be incomplete, namely in the case in which a non-sufficient number of components has been used. On the other hand, the decomposition may also be overcomplete, which would occur in the opposite case, i.e. in the case of an excessive number of singular values. An incomplete representation leads to a faulty reconstruction of the input signal from the superposition of the whole set of independent components. An increase of the number of extracted components leads to a smaller square error between the original audio signal and the reconstruction with all individual components.

The impression of an incomplete decomposition for a human listener consists in the disappearance of the weaker or rarer tones. On the other hand, an overcomplete decomposition causes the statistically outstanding instruments to occupy more extracted components than others. In order to avoid a detail loss and to suppress the extraction of quasi redundant components as much as possible, an inventive compromise is to perform a slightly (for example 10%) overcomplete decomposition with subsequent division of the components into individual subspaces, namely based on certain features for the components and/or component signals.

Subsequently, various embodiments of the means 16 for extracting are given. Specifically, various features are represented. Preferably, various features are used either individually or in combination for classification. These features are percussiveness, noise-likeness, spectral dissonance, the spectral flatness measure (SFM) or the third order cumulant. These five features may be used either individually or in any combination to control the classification, i.e. the association of the component signals with the subspaces 21, 22 performed by block 20 in FIG. 1 or FIG. 2.

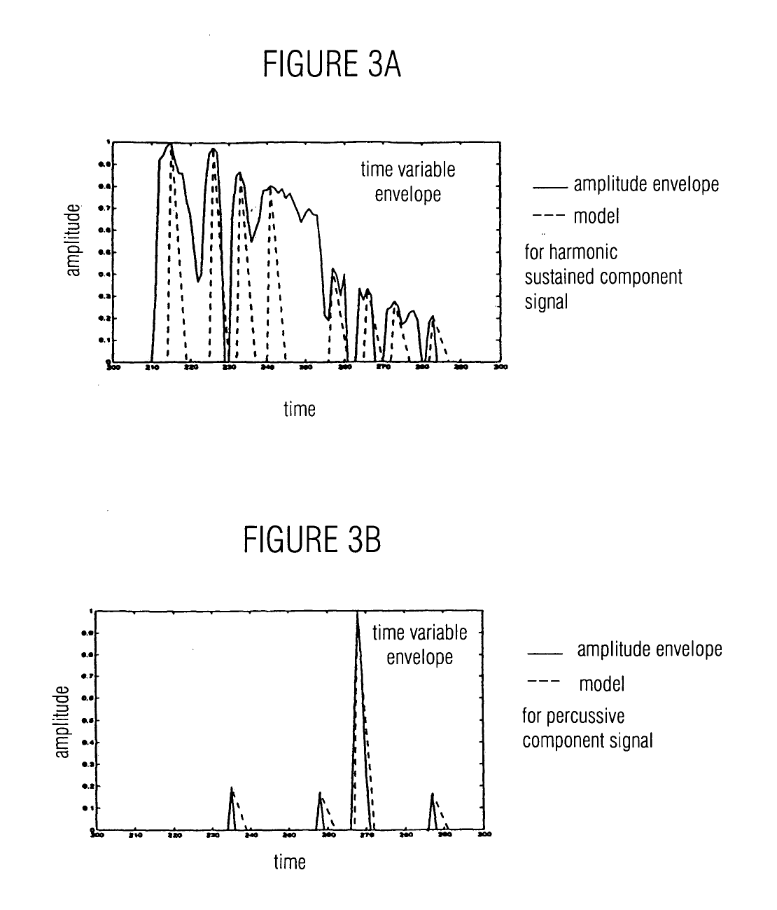

The percussiveness feature is extracted from the time varying amplitude envelopes. Thus, it is not the static spectrum F of a component signal that is observed for the feature of percussiveness, but the time varying amplitude envelope E of the component signal. It is further assumed that percussive components have impulses with a fast rise, i.e. a fast attack phase, and that the impulses further show a slower drop. Amplitude envelopes of components coming from harmonic sustained tones, however, have significant plateaus. The percussive impulses are modeled by using, for example, a simple model with an instant rise of the amplitude envelope and a linear drop to 0, for example within a time of 200 ms. This “model template” is folded with the local maxima of the amplitude envelope of a component signal. In other words, an amplitude envelope E of a component signal is taken and first subjected to processing to find the local maxima of the amplitude envelope. Then the local maxima and the corresponding areas of the amplitude envelope surrounding the local maxima are folded with the “model template”, i.e. with the model amplitude curve. The result is then a correlation coefficient of the model vector and the original vector representing a degree of percussiveness. For this see, for example, FIGS. 3a and 3b. FIG. 3a shows a time variable amplitude envelope for a harmonic sustained component signal in solid representation. The broken representation, however, shows a model envelope in which the model waveform is applied to the local maxima of the amplitude envelope in FIG. 3a in solid form. A relatively low correlation is shown, therefore there will be a relatively low correlation coefficient.

The case in FIG. 3b is very different, where an amplitude envelope is illustrated in solid representation for a percussive signal. Further, there is drawn a model curve in broken form, namely at the local maxima of the amplitude envelope. It can be seen that there is a close correlation between the solid line and the broken line, so that the result is a correlation coefficient having a significantly larger value than that for the correlation coefficient calculated for the conditions in FIG. 3a. The algorithm for the calculation of the percussiveness of a component signal thus provides higher values, i.e. a larger feature, for more percussive component signals than for non-percussive component signals for which the result is a smaller feature, i.e. a smaller percussiveness.

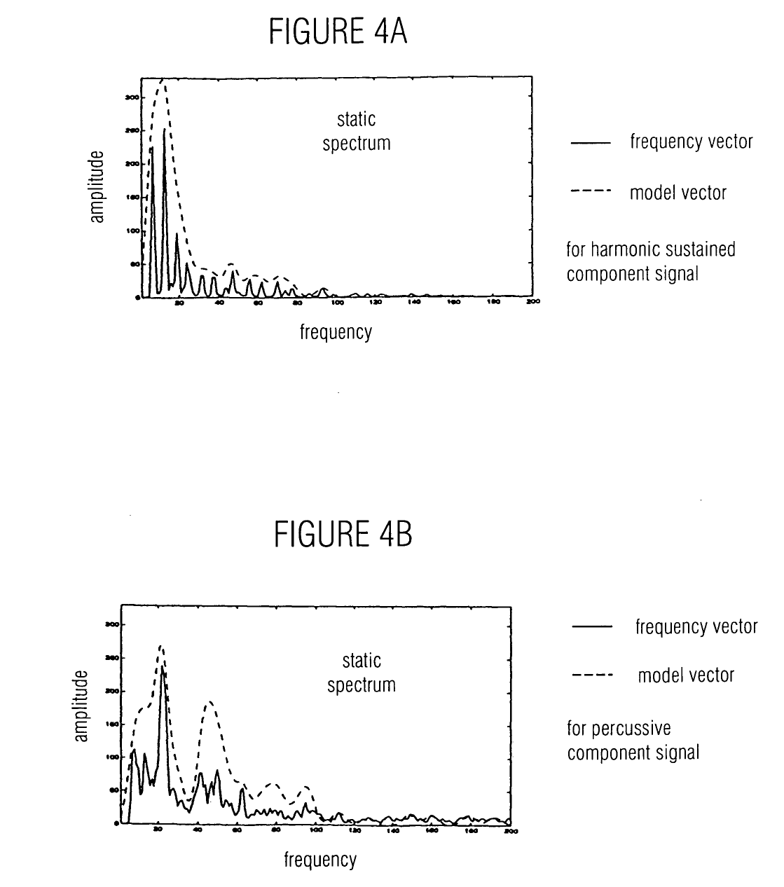

Using the percussiveness as feature in the means 16 for the component-wise feature calculation and using, for example, a subsequent threshold comparison in the means 20 for associating such that component signals with a percussiveness larger than a given threshold value are put into the percussive subspace 21, while other component signals with a percussiveness smaller than the threshold value are put into the non-percussive subspace 22. By this procedure, overall percussive component signals may thus be detected, i.e. they may be determined by the inventive analysis and, for example, be superimposed and reconstructed to perform, on the basis of these component signals, a rhythm extraction not disturbed by harmonic sustained component signals. On the other hand, a melody extraction and/or a note extraction or also an instrument detection could be performed on the basis of the component signals in the subspace 22 of FIG. 2, which is not affected by the percussive component signals and thus may lead to a better and faster result which particularly also requires less calculating time than when the entire signal including percussive and harmonic sustained component signals is subjected to a rhythm extraction or a note/melody detection as a whole. The following will discuss a further alternative feature with respect to FIGS. 4a and 4b which may be used either on its own or together with the feature of percussiveness by the means 20 for associating. The feature of noise-likeness is not calculated on the basis of the time variable envelope E like the feature of percussiveness, but on the basis of the static spectrum F. The noise-likeness is derived from the frequency vector of the components. It is extracted to quantify the degree of noise-likeness, which is to give the proximity of a component signal to the percussive subspace. According to the findings of W. Aures, Berechnungsverfahren fü den Wohlklang beliebiger Schallerzeugnisse, ein Beitrag zur gehörbezogenen Schallanalyse, Dissertation (in german), Technical University München, 1984 and R. Parncutt, Harmony: A Psychoacoustical Approach, Springer, N.Y., 1989, tonal spectra have outstanding narrow-band tones or partials as features, in contrast to atonal or noisy spectra which, if any, have only broadband partials, i.e. outstanding components from the spectrum. For calculating the feature of noise-likeness, there is first again performed an examination of the spectrum such that the local maxima are found. The local maxima are then folded with a Gaussian impulse with an average value of 0 and a variance σ, which is given as follows:

$$g ( x ) = exp ( - \frac{{x}^{2}}{2 {σ}^{2}} ) \qquad ( 8 )$$

The noise-likeness is then determined as the correlation coefficient of an original and a resulting model vector. FIG. 4a shows an original vector in solid form for a harmonic sustained component signal and a model vector in broken representation which results by folding each local maximum with a Gaussian impulse of the above form. The broken line in FIG. 4a is thus the result of a placement of a Gaussian impulse to each maximum and the corresponding summation of the individual Gaussian impulses.

FIG. 4a shows that there is a relatively low correlation between the frequency vector represented in solid form and the model vector represented in broken form. However, the situation is completely different in FIG. 4b. If the procedure of FIG. 4a is applied to FIG. 4b showing a percussive frequency vector in solid form, again a Gaussian impulse of the above form would be arranged at each local maximum of the waveform which, in FIG. 4b, is the solid waveform and represents the original signal, whereupon the resulting Gaussian impulses are summed. FIG. 4b shows clearly that there is a relatively high correlation between the model vector represented in broken form and the original frequency vector represented in solid form, so that the correlation coefficient will be high in the case of FIG. 4b indicating a percussive component signal, while the correlation coefficient will be small in FIG. 4a indicating, in turn, a harmonic sustained component signal. Thus also the feature of noise-likeness provides a sufficient characterization of a component signal for the means 20 for associating to be capable of performing an association which is very likely correct.

The feature of spectral dissonance is interesting for the percussiveness determination in that it is assumed that percussive tones do not contain more non-harmonic partials, i.e. spectral components, than harmonic sustained tones. This assumption motivates the extraction of a dissonance measure according to Sethares, as it is described in “Local Consonance and the Relationship between Timbre and Scale”, J. Acoust. Soc. Am., 94(3), vol. 1, 1993. The spectral dissonance is derived from the static frequency spectrum F of the independent components by adding up the dissonance of all spectral components in pairs. The dissonance d of two sinusoidal signals with frequencies f₁, f₂ and the amplitudes a₁ and a₂, respectively, is given as follows:
d(f₁,f₂,a₁,a₂)=a₁a₂(e^{-as(f}^{₂}^{-f}^{₁}⁾−e^{bs(f}^{₂}^{-f}^{₁₎}) (9)

According to the literature given above, the parameters a, b and s are set as follows:

$$a = 3 , 5 , b = 5 , 75 and s = \frac{0 , 24}{( 0 , 021 {f}_{1} + 19 )}$$

For determining the spectral dissonance, all frequency lines in the spectrum are evaluated, wherein the maxima in a spectrum provide the largest contribution to the dissonance, while small spectral lines provide a small contribution, for example in the spectrum of FIG. 4a or FIG. 4b. Thus the dissonance between each pair of spectral components is performed in an exhaustive search, so that, for the spectrum of FIG. 4a, there will be a certain value which will be relatively small, because the spectrum is harmonic, i.e. non-dissonant, while, for FIG. 4b, there will be a relatively large value indicating that the spectrum in FIG. 4b is spectrally dissonant, i.e. it does not come from a harmonic sustained instrument, but from a percussive instrument.

The feature of spectral flatness describes the flatness properties of a spectrum of an audio signal, such as illustrated in FIGS. 4a and 4b. Thus it is assumed that percussive components have flatter spectra than harmonic sustained components. According to International Standards Organization (ISO), Information Technology—Multimedia Content Description Interface—Part 4: Audio, ISO-IEC 15938-4 (E), 2001, the feature SFM is calculated as ratio of the geometric mean to the arithmetic mean of the power spectrum coefficients as follows:

$$SFM ( x ) = \frac{\sqrt[N]{{\prod }_{n = 1}^{N} {x}_{n}}}{\frac{1}{N} {\sum }_{n = 1}^{N} {x}_{n}} \qquad ( 10 )$$

Here, N represents the number of frequency values or frequency bins of the power spectrum x. The vector x is equal to the one element-wise squared column vector of F, i.e. the static spectrum for a component signal. In turn, on the basis of the SFM feature, for example using a threshold value decision, there may be performed an association of the component signals into a percussive subspace or a non-percussive subspace, respectively, on the basis of the calculated SFM values.

With respect to the feature of the third order cumulant, it is to be noted that all features may be used that may be calculated from higher order statistics. The use of higher order statistics with respect to the independent components as distance measure between the components is, for example, described in the literature by Dubnov listed above, which has been discussed under the literature no. 5 mentioned above. In this case, the means for component-wise feature calculation designated 16 in FIG. 1 operates to transform the static spectrum, for example of FIG. 4a or FIG. 4b, to the time domain by using an inverse short-time transform to obtain a time signal x. After that, the third order cumulant is calculated as represented by the subsequent equation:
TOC(x)=E{x³}−3E{x²}E{x}+2[E{x}]³ (11)

Here E {.} represents the expectation operator and x represents the time signal. Using the feature TOC (Third Order Cumulant), an association of component signals with subspaces may be performed again based on a threshold value decision, for example in the means 20.

It is to be noted at this point that the above features are particularly well suited to distinguish percussive component signals from non-percussive component signals. It is to be noted, however, that other features are likely to be necessary to distinguish, for example, violin-like component signals from flute-like component signals. Thus, according to the present invention, any component signals may be distinguished from any component signals when one feature is extracted, respectively, which is correlated with the source characteristics provided for the individual subspaces via which the distinction is to be made by the grouping into the subspaces.

It is preferred that the means 20 for classifying and/or associating is designed to use not only one feature, but a plurality of features to achieve an association of the component signals.

In one embodiment, it is preferred to use first the feature providing the highest reliability. It is to be noted that the reliability of a feature may be determined based on several test runs. Thus, first a decision is made on the basis of the most reliable feature such that the component signals having a feature above a threshold which may be predetermined are supplied to a next decision stage, while the others which have already failed at this first hurdle are classified into another subspace. Thus, however, there may still be present component signals which have passed the first decision threshold, but which are possibly wrong decisions in that these component signals, for example, do not have a percussive property, but only by chance obtained a feature that would indicate a percussive property. These wrong decisions are now filtered out by comparing additional features with their respective threshold. Finally, after a superposition of the individual component signals in the subspaces 21 and 22 of FIG. 1 and FIG. 2, respectively, two index vectors p and h result, wherein p contains the indices of the components classified as percussive, while h includes all components, i.e. those that are not percussive and that are assumed to come from harmonic sustained individual sources.

As soon as the independent components have been associated either with the percussive or the harmonic sustained subspace, it is preferred to generate two audio data streams independent of each other by reconstruction means 26 of FIG. 2. This is achieved by performing a matrix multiplication of the parts of E including the time varying amplitude envelopes and F containing the static frequency weightings, wherein the rows and columns, respectively, of E and F to be multiplied have been achieved by the classification of the subspaces, that is by p and h. The expression
Sₚ=F_{u,p}E_{p,v}
results in a reconstructed amplitude spectrogram corresponding to the percussive part of the input spectrogram X. Correspondingly,
Sₕ=F_{u,h}E_{h,v}
provides the harmonic sustained part.

Finally, it is preferred in one embodiment of the present invention to add the originally split off phase information φ, present in the form of a matrix, by performing an element-wise multiplication given by the following equation:
S_{u,v}=S_{u,v}(cos(Φ_{u,v})+j sin(Φ_{u,v}))

After the phase multiplication, we have now a phase-containing spectrogram, i.e. a sequence of already weighted spectra, which is sent through an inverse short-time Fourier transform and/or generally through a frequency-time conversion which is inverse with respect to the time-frequency conversion used in block 12a. This frequency-time conversion takes place for each weighted short-time spectrum, so that, after the transformation, the result is again a stream of audio samples, but now a stream containing only percussive component signals, i.e. which may be referred to as percussive track, and a stream having only signals from harmonic sustained sources, wherein this stream is also referred to as harmonic sustained track.

For evaluating the inventive concept, drum components were extracted from a database of nine example signals. The duration of each of these test pieces was 10 seconds. The test files were sampled with a sample rate of 44100 Hz and a 16-bit amplitude resolution. The test pieces involve various musical values ranging from big band pieces to rock pop pieces and electronic pieces of music. This examination has shown that all described features achieved reliabilities of more than 70%, while the feature of noise-likeness provided the best results with a reliability of 95%.

It is to be noted at this point that there may be quiet partial signals in high frequency bands which have little energy and few partial tones and are therefore statistically not significant enough and are thus removed by the dimension reduction (for example Hihats). By means of, for example, frequency selective preprocessing, it is therefore preferred to amplify these partial signals in the information signal prior to the decomposition taking place.

In particular, an “enhancer” is used for preprocessing. First the information signal is filtered with a high-pass. The high-pass filtered information signal is then harmonically distorted. The resulting signal is added to the original signal. By this, “artificial” partial tones are added to the signals.

It is further preferred to perform postprocessing of the component signals prior to the feature extraction. The amplitude envelopes may be postprocessed by means of a dynamic amplitude processing, which in the art is also referred to as “noise gate”. The aim is the removal of artifacts in the individual sources coming from other partial signals and containing only little energy. Assuming that a percussive component contains a number of percussive attacks, artifacts of other partial signals may occur between the attacks which become noticeable as noise carpet. They may be suppressed, for example, with the help of the noise gate, i.e. a noise suppression.

Depending on the circumstances, the inventive method for analyzing an information signal may be implemented in hardware or in software. The implementation may be done on a digital storage medium, particularly a floppy disk or a CD with control signals that may be read out electronically, which may cooperate with a programmable computer system so that the inventive method is performed. Generally, the invention thus also consists in a computer program product with a program code stored on a machine-readable carrier for performing the inventive method, when the computer program product runs on a computer. In other words, the invention may thus be realized as a computer program with a program code for performing the method, when the computer program runs on a computer.

While this invention has been described in terms of several preferred embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

What is claimed is:

1. A device for analyzing an information signal, wherein the information signal is an audio signal consisting of a superposition of partial signals, wherein the partial signals originate from individual sources together forming the audio signal, wherein the device includes:
a unit for decomposing the information signal into several component signals;
a unit for calculating a feature for each individual component signal, wherein the feature is defined so that it is correlated with one source characteristic for one subspace and with another source characteristic for another subspace, wherein one or more individual sources are associated with each subspace, and wherein the one or more individual sources associated with the one subspace differ from the one or more individual sources associated with the other subspace; and
a unit for associating the component signals with at least two subspaces on the basis of the features for the component signals, so that the one subspace includes component signals corresponding to the one or more individual sources associated with the one subspace, and that the other subspace includes component signals corresponding to the one or more individual sources associated with the other subspace.

2. The device according to claim 1, further comprising:
a unit for reconstructing the component signals associated with a subspace to obtain a reconstructed information signal, wherein the reconstructed information signal is based on a partial signal of an individual source or on a superposition of partial signals of a group of individual sources.

3. The device according to claim 1, wherein the unit for decomposing comprises a time-frequency conversion unit to obtain a sequence of short-time spectra from the information signal.

4. The device according to claim 3, wherein the unit for decomposing is further designed to calculate a sequence of short-time magnitude spectra as sequence of short-time spectra.

5. The device according to claim 3, wherein the unit for decomposing is designed to perform a singular value decomposition with the sequence of short-time spectra to obtain singular values indicating the component signals.

6. The device according to claim 5, wherein the unit for decomposing is further designed to select a number of singular values from all obtained singular values whose magnitude is larger than a threshold value.

7. The device according to claim 6, wherein the number of selected singular values is larger than a number of individual sources expected for the information signal.

8. The device according to claim 1, wherein the unit for decomposing is designed to determine a component signal as a static amplitude spectrum and an associated time-variable amplitude envelope.

9. The device according to claim 1, wherein the unit for calculating is designed to calculate a plurality of different features for a component signal.

10. The device according to claim 9, wherein the unit for associating is designed to perform a multistage association, wherein a more reliable feature is usable in a first stage of the association, and wherein a less reliable feature is usable in a second, downstream stage.

11. The device according to claim 1, wherein the feature is a quantitative feature, wherein the unit for associating is designed to operate on the basis of a quantity of the feature.

12. The device according to claim 1, wherein the unit for associating is designed to operate using a predetermined threshold, wherein an association of a component signal with a subspace is based on whether the feature for the component signal is larger or smaller than the predetermined threshold.

13. The device according to claim 1, wherein the unit for calculating is designed to calculate a feature which is meaningful with respect to an association of an individual source with a type of sound generators.

14. The device according to claim 13, wherein the information signal includes a music signal and the unit for calculating is designed to use a feature which is meaningful with respect to a type of music instruments.

15. The device according to claim 1, wherein the individual sources include non-percussive and percussive individual sources, wherein the unit for calculating is designed to use a feature as feature that is correlated with a percussiveness of a component signal, so that component signals found percussive are associated with a first subspace by the unit for associating, and that component signals found non-percussive are associatable into a second subspace.

16. The device according to claim 1, wherein the component signal is an amplitude envelope, wherein the unit for calculating is designed to use a percussiveness of a component signal as feature, wherein the unit for calculating comprises:
a unit for providing a model time curve for a maximum in a component signal;
a unit for processing the component signal such that a model signal is arranged at each maximum on the basis of the model time curve, so that the result is a model signal associated with the component signal; and
a unit for calculating a similarity between the model signal and the component signal to obtain a similarity measure which is usable as feature by the unit for associating.

17. The device according to claim 1, wherein the component signal is an amplitude spectrum, wherein the unit for calculating is designed to use a noise-likeness as feature, wherein the unit for calculating comprises:
a unit for determining local maxima in a component signal;
a unit for processing the component signal such that a Gaussian-shaped impulse is associated with each maximum to obtain a model waveform for the component signal; and
a unit for determining a similarity between the spectrum of the component signal and the model signal giving a noise-likeness of the component signal.

18. The device according to claim 1, wherein the unit for calculating is designed to calculate a spectral dissonance measure as feature for a static spectrum of a component signal.

19. The device according to claim 1,
wherein the unit for calculating is designed to calculate a spectral flatness measure of a static amplitude spectrum of a component signal as feature.

20. The device according to claim 1, wherein the unit for calculating is designed to calculate a third order cumulant for a static amplitude spectrum of a component signal converted to the time domain as feature.

21. The device according to claim 1, wherein a multistage decision is performable by the unit for associating, wherein a first decision stage is based on a feature of noise-likeness, and a downstream decision stage is based on a feature of spectral dissonance, percussiveness, third order cumulant or spectral flatness measure.

22. The device according to claim 2, wherein the unit for reconstructing is further designed to re-add phase information removed in a decomposition of the information signal to obtain a reconstructed information signal for a subspace.

23. The device according to claim 1, wherein the unit for associating is designed to associate a component signal with one of more than two subspaces on the basis of one or more features of the same.

24. The device according to claim 2, further including a unit for extracting a feature from a reconstructed information signal which is generatable from a superposition of component signals in a subspace.

25. The device according to claim 1, further comprising a unit for pre-processing the information signal to selectively increase a partial signal in the information signal with respect to its energy.

26. The device according to claim 1, wherein the unit for decomposing is further designed to post-process the component signals prior to the feature extraction to reduce artifacts in a component signal coming from other partial signals.

27. A method for analyzing an information signal, wherein the information signal is an audio signal consisting of a superposition of partial signals, wherein the partial signals originate from individual sources together forming the audio signal, the method comprising:
decomposing the information signal into several component signals;
calculating a feature for each individual component signal, wherein the feature is defined so that it is correlated with one source characteristic for one subspace and with another source characteristic for another subspace, wherein one or more individual sources are associated with each subspace, and wherein the one or more individual sources associated with the one subspace differ from the one or more individual sources associated with the other subspace; and
associating the component signals with at least two subspaces on the basis of the features for the component signals, so that the one subspace includes component signals corresponding to the one or more individual sources associated with the one subspace, and that the other subspace includes component signals corresponding to the one or more individual sources associated with the other subspace.

28. A computer program with a program code for performing a method for analyzing an information signal, when the program runs on a computer, wherein the information signal is an audio signal consisting of a superposition of partial signals, wherein the partial signals originate from individual sources together forming the audio signal, the method comprising the steps of decomposing the information signal into several component signals; calculating a feature for each individual component signal, wherein the feature is defined so that it is correlated with one source characteristic for one subspace and with another source characteristic for another subspace, wherein one or more individual sources are associated with each subspace, and wherein the one or more individual sources associated with the one subspace differ from the one or more individual sources associated with the other subspace; and associating the component signals with at least two subspaces on the basis of the features for the component signals, so that the one subspace includes component signals corresponding to the one or more individual sources associated with the one subspace, and that the other subspace includes component signals corresponding to the one or more individual sources associated with the other subspace.
